(19) United States
(12) Patent Application Publication
(10) Pub. No.: US 2021/0373632 A1
(43) Pub. Date: Dec. 2, 2021

(54) REMOVABLE COMMUNICATION DEVICE

(71) Applicants: Chatilla van Grinsven, Rosmalen (NL); George Sean Garrett, Sherborn, MA (US)

(72) Inventors: Chatilla van Grinsven, Rosmalen (NL); George Sean Garrett, Sherborn, MA (US)

(21) Appl. No.: 17/404,866

(22) Filed: Aug. 17, 2021

Related U.S. Application Data
(63) Continuation-in-part of application No. 16/233,029, filed on Dec. 26, 2018.
(60) Provisional application No. 62/609,710, filed on Dec. 22, 2017.

(51) Int. Cl. G06F 1/26; H04L 29/08; G06F 1/32

(52) U.S. Cl. CPC G06F 1/266; G06F 1/32; H04L 67/125

(57) ABSTRACT

A removable communication device is described herein. The removable communication device is configured to communicatively couple to a variety of receiving devices via a physical and/or electrical connection. When coupled the removable communication device can control the variety of receiving devices at least in part by using a touchscreen user interface located on the removable communication device.

### RELATED APPLICATIONS

This non-provisional patent application is a continuation-in-part application, claims priority to, and incorporates by reference in its entirety U.S. non-provisional patent application Ser. No. 16/233,029 filed Dec. 26, 2018, which claims priority to U.S. provisional patent application 62/609,710 filed Dec. 22, 2017, which is also incorporated by reference in its entirety.

### BACKGROUND

Individuals own many different types of electronic devices and home devices that may not have additional smart features, such as voice control, when they are originally purchased. Individuals may want to improve the functioning of these devices and control them with a removable communication device configured to be communicatively coupled to one or more electronic device(s) and/or home device(s). People may be looking for an all-in-one removable communication device that is configured to improve the functioning of their electronic devices and/or home devices.

Furthermore, many individuals take multiple electronic devices with them when they leave their homes. For example, when people go to the gym, they must carry their smartphones separately from their headphones as their smartphones are not configured to make a physical connection to their headphones. Additionally, if the headphones are connected to the smartphone via Bluetooth, the smartphone must stay in close proximity to the headphones in order to stay connected to the headphones. People may be looking for a hands-free, all-in-one method of making phone calls, listening to music, and operating their other electronic and home devices with one removable communication device.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a schematic view illustrating an example environment in which a removable communication device is operating, in accordance with one or more examples. The example environment can include the removable communication device, one or more electronic device(s) configured to be communicatively coupled to the removable communication device, and a network.

FIG. 2 is a block diagram illustrating components of a removable communication device, according to examples of the present disclosure.

FIG. 3 is a schematic view of an example of a removable communication device making a physical and/or electrical connection to a receiving device, in accordance with examples of the disclosure.

FIG. 4 is a flow diagram illustrating an example method of connecting a removable communication device to multiple receiving devices configured to receive the removable communication device.

FIG. 5 is a flow diagram of an example process for configuring a removable communication device for use as a primary communication device, in accordance with examples of the disclosure.

FIG. 6 is a schematic diagram of an illustrative user interface of a removable communication device in accordance with examples described herein.

The figures depict various examples for purposes of illustration only. One skilled in the art will readily recognize from the following discussion that alternative examples of the structures and methods illustrated herein may be employed without departing from the principles described herein.

### DETAILED DESCRIPTION

As discussed above, individuals may want to control their many electronic devices and home devices using one removable communication device. Individuals may also be looking for a hands-free, all-in-one method of making and answering phone calls and listening to music, negating the need to use and carry a separate smartphone when working out at the gym and listening to music via headphones.

This application relates to techniques for a removable communication device to make a physical and/or electrical connection to other devices in order to improve their functioning as well as enables them to be controlled and operated in a hands-free manner, if desired.

The techniques described herein can be implemented in a number of ways. Examples are provided below with reference to the following figures. Although discussed in the context of a removable communication device, the methods and apparatuses described herein can be applied to a variety of systems (e.g., smartphones), and need not be limited to specific examples of removable communication devices described herein.

The removable communication device includes a touchscreen and can include or be configured to receive or attach to a cover located on a side opposite the touchscreen. The removable communication device includes a housing enclosing one or more of the component(s) of the removable communication device, in whole or in part. In some examples, the housing of the removable communication device is between at least about 50 millimeters and at most about 100 millimeters in diameter. In some examples, the housing of the removable communication device is between at least about 60 millimeters and at most about 90 millimeters in diameter. In some examples, the housing of the removable communication device is between at least about 70 millimeters and at most about 80 millimeters in diameter. In some examples, the housing of the removable communication device is formed at least in part from plastic, metal, and/or ceramic. The removable communication device can include one or more processor(s), one or more computer readable media, a battery system, a memory unit, a microphone, a camera, a radio configured to connect to at least one of a CDMA or a GSM network antenna, and one or more sensor(s).

In some examples, the removable communication device is configured to operate as a smartphone, negating the need to use a separate smartphone. For example, the removable communication device may be configured to connect to at least one of a CDMA or a GSM network antenna. The removable communication device may be configured to send and receive phone calls and texts, and access internet via data provided by the mobile network. The removable communication device may be useful for playing music, audio navigation, playing videos, providing map services, and accessing an app store to download apps, as well as any other functions that a smartphone has.

The removable communication device is configured to make a physical and/or electrical connection to one or more device(s) that are configured to receive the removable communication device. In some examples, the housing of the removable communication device includes a protrusion and/or indentation arranged to receive a cover on the side opposite the touchscreen, which can attach via a pressure fit, magnetic connection, etc. In some examples, the receiving device may be a headset, a thermostat, a television, a speaker, or any other device configured to receive and communicate with the removable communication device.

The removable communication device can be configured to control the receiving device while the removable communication device remains in communication with the receiving device. In some examples, the removable communication device can control certain functions of the receiving device using the touchscreen on the removable communication device. In some examples, the removable communication device can use a voice command to control certain functions of the receiving device.

In some examples, the receiving device may be a first receiving device of a first type. The removable communication device may make another physical and/or electrical connection to a second receiving device, wherein the second receiving device is of a second type that is different than the first type. The removable communication device can be configured to control the receiving device of the first type differently than how it controls the receiving device of the second type.

In some examples, the removable communication device is configured to share battery power with the receiving device while the removable communication device is in physical and/or electrical connection with the receiving device. In some examples, the removable communication device is configured to receive power and/or recharge its battery with power flowing from the receiving device while the removable communication device is in physical and/or electrical connection with the receiving device.

In some examples, the removable communication device can share data with the receiving device while the removable communication device is in communication with the receiving device. Shared data may include photos, audio, video, internet capability, and other types of data that the receiving device is configured to share and/or receive.

In some examples, once the removable communication device has made a physical and/or electrical connection to the receiving device, the touchscreen of the removable communication device is configured to present a customized user interface specific to the receiving device. In some examples, the receiving device is a first receiving device of a first type, and the touchscreen of the removable communication device can present a customized user interface specific to the first device of a first type. The customized user interface can display at least one feature specific to controlling the first device of the first type.

In some examples, the removable communication device is configured to detect a smartphone in proximity to the removable communication device. The smartphone can be configured for use as a primary communication device and the removable communication device can be configured for use as a secondary communication device. A primary communication device is a communication device that is in proximity to the user and can be the focus of the user's attention, engagement, or focus. A secondary communication device can include any other communication device that is in proximity to the user that does not have the user's attention, engagement, and/or focus. In some examples, when the removable communication device no longer detects the smartphone in proximity to the removable communication device, the removable communication device can prompt the user to configure it as the primary communication device. In some examples, when the removable communication device ceases to detect the smartphone in proximity, the removable communication device automatically configures itself for use as the primary communication device.

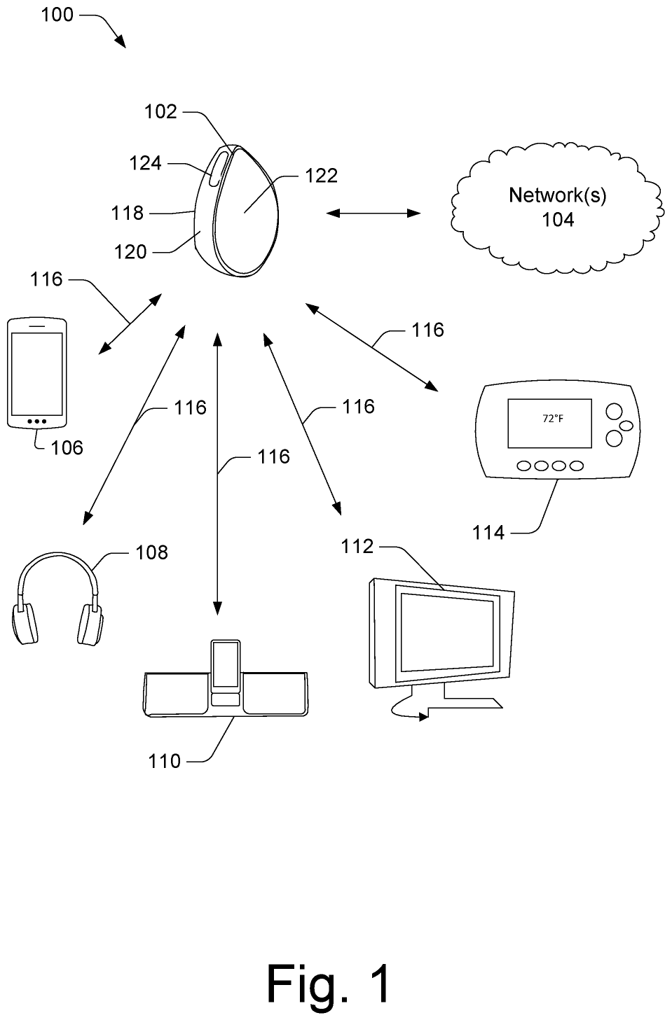

FIG. 1 is a schematic view of an example environment 100 including a removable communication device 102. Removable communication device 102 is configured to communicate via a network(s) 104. Among other things, network(s) 104 enables removable communication device 102 to be used as a smartphone device separate from a user's smartphone. For example, removable communication device 102 can be configured to send and receive phone calls and/or texts, and/or access the internet via network(s) 104.

In the illustrated example, removable communication device 102 is configured to be communicatively coupled with multiple different types of electronic devices and/or computing devices in environment 100, including a smartphone 106, headphones 108, a speaker 110, a television 112, a thermostat 114, and other electronic devices that are configured to communicatively couple to and/or are configured to make a physical and/or electrical connection, as designated by arrows 116, to removable communication device 102 according to the described techniques. This is merely an example environment and the multiple electronic devices and/or computing devices in the environment 100 can constitute any other device or devices configured to communicatively couple to and/or are configured to make a physical and/or electrical connection to removable communication device 102.

Examples of electronic devices include, but are not limited to, wearable devices (e.g., headsets, helmets, etc.), mobile devices (e.g., smartphones, tablets, etc.), electronic devices found in the home (television, computer, thermostat, etc.), vehicles, and/or other portable or stationary electronic devices. In some examples, the housing 118 of removable communication device 102 is between at least about 50 millimeters and at most about 90 millimeters in diameter. In some examples, the housing may have a round, square, rectangular, tear drop, or other shape. In some examples, the housing of removable communication device 102 may have a curved shape so that removable communication device 102 does not lay flat.

In some examples, the housing 118 of removable communication device 102 is formed at least in part from plastic, metal, and/or ceramic. In some examples, the housing 118 can include one or more solar collector(s). For example, an outer rim of the housing 118 can include a solar collector that can operate as a solar panel to capture solar power.

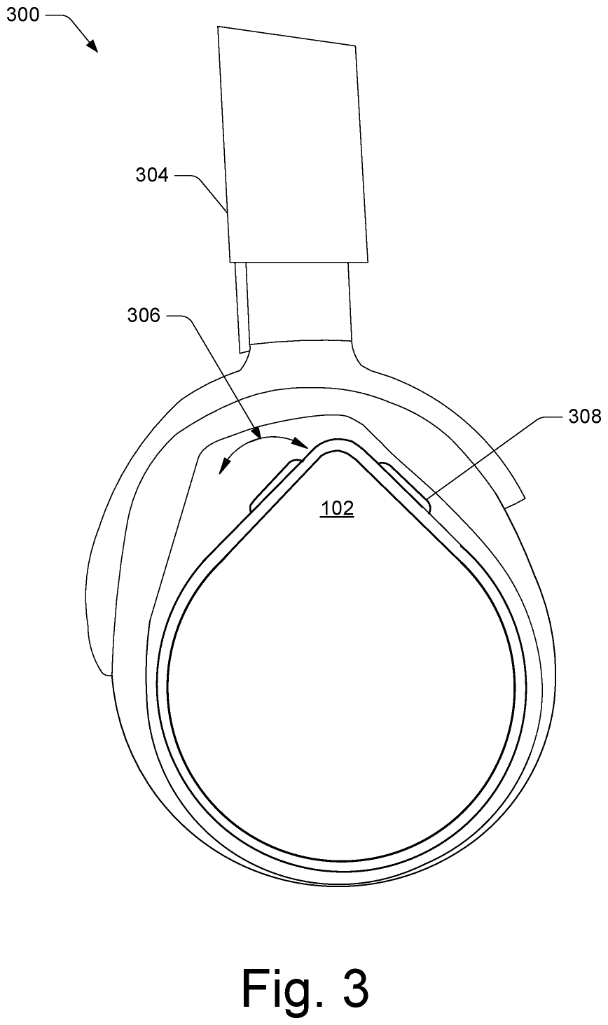

In some examples, the housing 118 of removable communication device 102 includes a notch which can physically connect the removable communication device 102 to a protrusion of a receiving device. The physical and/or electrical connection is discussed in more detail in the description of FIG. 3.

In some examples, the housing 118 can have an associated cover 120 located on a side opposite the touchscreen 122. In some examples, the cover 120 can be interchangeable with other covers. In some examples, the cover 120 can be removed before removable communication device 102 makes a physical and/or electrical connection to a receiving device. In some examples, the housing 118 includes one or more mechanical button(s) 124. The mechanical button(s) 124 can be located on the housing 118 of removable communication device 102. In some examples, pushing or activating the mechanical button(s) 124 can activate different applications and/or features on removable communication device 102. For example, pushing the mechanical button(s) 124 can bring up a timer on the user interface 218 of removable communication device 102. In some examples, pushing the mechanical button(s) 124 can bring up a virtual assistant. In some examples, pushing the mechanical button(s) 124 can increase or decrease the volume of sound output by speakers associated with the removable communication device 102.

In some examples, the function of the mechanical button(s) 124 can change depending on the current application that is actively running on the removable communication device 102 and/or based on what is displayed on the user interface 218 of removable communication device 102. For example, if a music application is active on the removable communication device 102, the mechanical button(s) 124, when pushed or pressed, can be used to increase, or decrease the volume of the music.

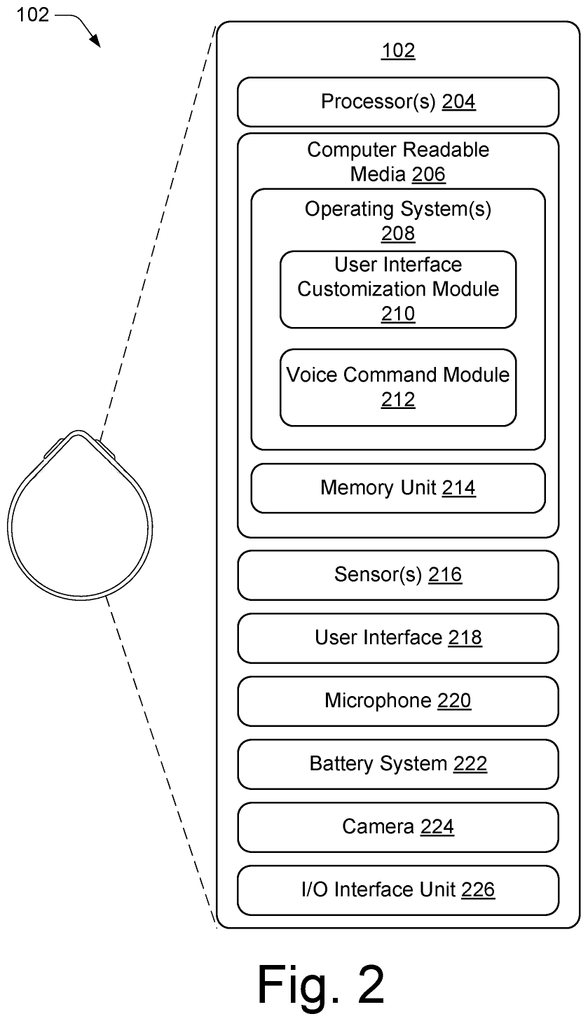

FIG. 2 depicts a block diagram of example internal components that can be included in a removable communication device 102.

As shown in FIG. 2, removable communication device 102 can include a processor(s) 204, a computer readable media 206, an operating system 208, a user interface customization module 210, a voice command module 212, a memory unit 214, sensor(s) 216, a user interface 218, a microphone 220, a battery system 222, and a camera 224, and/or an input/output (I/O) interface unit 226. There may be more or fewer components in or on removable communication device 102 than what is shown in FIG. 2. In some examples, the microphone 220 can be external to the removable communication device 102.

Removable communication device 102 includes a processor(s) 204. In various examples, the processor(s) 204 can include one or more of a central processing unit (CPU), a graphics processing unit (GPU), a microprocessor, a digital signal processor, Alternatively, or in addition, the processing described herein can be performed, at least in part, by one or more hardware logic component(s). For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each processor(s) 204 can possess its own local memory, which also can store programs, program data, and/or one or more operating system(s). Furthermore, the processor(s) can include one or more core(s).

The computer-readable media 206 includes the memory unit 214, which can include volatile and nonvolatile memory and/or removable and non-removable media implemented in any type of technology for storage of information, such as computer-readable instructions, data structures, program modules, or other data. Such computer-readable media 206 can include, but is not limited to, random access memory (RAM), read-only memory (ROM), electrically erasable programmable read-only memory (EEPROM), flash memory or other memory technology, optical storage, solid state storage, magnetic tape, magnetic disk storage, redundant array of independent disks storage systems, storage arrays, network attached storage, storage area networks, cloud storage, or any other medium that can be configured to store the desired information and that can be accessed by removable communication device 102. The memory unit 214 can store an operating system 208 and one or more software application(s), instructions, programs, and/or data to implement the methods described herein and the functions attributed to the various examples.

The computer-readable media 206 can be used to store any number of functional components that are executable by the processor(s) 204. In some examples, these functional components comprise processor-executable instructions or programs that are executable by the processor(s) 204 and that, when executed, specifically configure the processor(s) 204 to perform the actions/operations attributed above to removable communication device 102. Functional components stored in the computer-readable media 206 can include the operating system 208 for controlling and managing various functions of removable communication device 102, and the memory unit 214. The operating system can control the functions of removable communication device 102 in a similar way to most other smartphones and/or computers. The operating system, in conjunction with application programs known as “Apps” executes functions in response to user commands. The computer-readable media 206 can include or maintain other functional components and data, such as other modules and data, which can include programs, drivers, etc., and the data used or generated by the functional components.

Removable communication device 102 can include an operating system 208 being executed on the processor(s) 204. Example operating system(s) 208 can include Android (Google), iOS (Apple), Windows OS (Microsoft), Firefox OS, Blackberry OS, Symbian OS (Nokia), Tizen (Samsung), Bada (Samsung), etc.

Removable communication device 102 can include a user interface customization module 210. The user interface customization module can customize the one or elements and/or graphical images displayed on the user interface 218 based at least in part on the receiving device and/or the type of receiving device the removable communication device 102 is communicatively coupled to 116.

Removable communication device 102 can include a voice command module 212 configured to transform a voice communication received from the microphone 220 and convert the voice communication into an electrical signal. The voice command module 212 can be configured to recognize and take commands from a specific user or a plurality of users. The voice command module 212 can analyze the specific user's voice and fine tune recognition of the specific user's speech to create an accurate profile of the user's voice, such that the voice command module 212 can recognize and understand voice commands.

Removable communication device 102 can include a virtual assistant application to interface with the voice command module 212. For example, the user can use their voice communication to utilize the voice command module 212, and the virtual assistant application can recognize and understand the voice communication and answer back via a synthesized voice. The virtual assistant application can receive the voice communication, determine a response to the voice communication by selecting from a plurality of preprogrammed words and phrases, and transmit a chosen word or phrase via a speaker.

Removable communication device 102 can include one or more sensor(s) 216. The one or more sensor(s) 216 can include lidar sensors, radio sensors, location sensors (e.g., global positioning system (GPS), compass, etc.), inertial sensors (e.g., inertial measurement units (IMUs), accelerometers, magnetometers, gyroscopes, etc.) camera sensors (intensity, depth, infrared camera, red-green-blue (RGB) color sensor), microphone sensors, and/or environment sensors (temperature sensors, humidity sensors, light sensors, pressure sensors, etc.), etc. Removable communication device 102 can include multiple instances of each of these or other types of sensor(s) 216. The sensor(s) 216 can be located in different locations on removable communication device 102, including in a housing 118, on the rim of removable communication device 102, on a touchscreen 122, or other locations.

In some examples, removable communication device 102 includes a biometric sensor which operates to sense one or more biometric parameter(s) of the user. The biometric parameters can then be displayed on the user interface 218 of removable communication device 102. This information can also be stored in the memory unit 214.

In some examples, removable communication device 102 includes a proximity sensor that can detect the presence of electronic devices that are located near removable communication device 102

In some examples, removable communication device 102 includes a light sensor that measures the brightness level of ambient light. The data received from the light sensor can be used to adjust the touchscreen 122 brightness automatically.

In some examples, removable communication device 102 includes a barometer sensor that measures atmospheric pressure. Data received from the barometer sensor can be used to determine how high the removable communication device 102 is above sea level, which in turn results in improved GPS accuracy.

In some examples, removable communication device 102 includes a gravity sensor and capacitance plates. The gravity sensor measures changes in the distance between the capacitance plates caused by motion on three axes (X, Y, and Z), and determines the instantaneous acceleration and deceleration forces accordingly.

In some examples, removable communication device 102 includes a gyroscope sensor that senses angular rotational velocity and acceleration. The gyroscope sensor can also detect a geomagnetic orientation of the removable communication device 102.

In some examples, removable communication device 102 can receive sensor data provided by receiving device(s) from one or more sensor(s) associated with the receiving device(s). For example, the receiving device(s) can provide removable communication device 102 sensor data from a variety of sensor(s) including one or more of lidar sensors, radio sensors, location sensors (e.g., global positioning system (GPS), compass, etc.), inertial sensors (e.g., inertial measurement units (IMUs), accelerometers, magnetometers, gyroscopes, etc.) camera sensors (intensity, depth, infrared camera, red-green-blue (RGB) color sensor), microphone sensors, and/or environment sensors (temperature sensors, humidity sensors, light sensors, pressure sensors, etc.), etc. In some examples, removable communication device 102 can acquire data from removable communication device(s) 102 and/or one or more sensor(s) associated with the receiving device(s) when removable communication device(s) 102 have communicatively coupled to and/or are physically and/or electrically connected to the receiving device(s).

The user interface 218 can include a touchscreen 122 that is communicatively coupled to the processor(s) 204. The touchscreen 122 is configured to receive a user input or user command (e.g., via the user moving a finger from left to right or up or down on the touchscreen 122). The touchscreen 122 can include a force sensor that senses a touch force applied by the user on the touchscreen 122. The force sensor can analyze the touch force and can, based on the touch force, select a command based on a predetermined criterion.

In some examples, removable communication device 102 is configured to control the receiving device(s) using the touchscreen 122 associated with the removable communication device 102. The removable communication device's 102 user interface 218, in some examples, can be customized to display certain features and/or options depending on the receiving device or the type of receiving device the removable communication device 102 is communicatively coupled to. For example, if the receiving device is headphones 108, removable communication device 102 can display a customized user interface 218 that displays features and/or options relevant to the use and/or control of the headphones 108. For instance, the customized user interface 218 can display the current song that the user is listening to while using the headphones 108.

In some examples, if the receiving device is a thermostat 114, removable communication device 102 can display a customized user interface 218 that displays features relevant to the use of the thermostat 114. For example, removable communication device 102 can display temperature settings when the removable communication device 102 is communicatively coupled to and/or is physically and/or electrically connected to the thermostat 114. Removable communication device 102 can also be used to change the heating or cooling settings of the thermostat 114 using the touchscreen 122, or via a voice command.

Removable communication device 102 can include a microphone 220. A microphone 220 can receive audio input to control the removable communication device 102, to use the removable communication device 102 as a stand-alone communication device, and/or to control one or more receiving device(s) such as the receiving devices described herein.

Removable communication device 102 can include a battery system 222. The battery system 222 can have an associated rechargeable battery, such as a lithium-ion battery, a lithium-polymer battery, or a nickel-metal hydride battery. In some examples, the battery system 222 includes a magnetic inductive charging unit. The magnetic inductive charging unit can magnetically connect to the housing of removable communication device 102 and can wirelessly connect to the battery system 222. The magnet inductive charging unit operates to wirelessly transfer energy to the battery system 222. In some examples, the battery system 222 includes a bidirectional power bus which enables the transmission and reception of power between the removable communication device 102 and a receiving device.

In some examples, the camera 224 can operate to capture images, videos, track a face, fingers, gestures, and/or other biometric personal data of the user using an optical sensor(s) and the processor(s) 204 can operate to analyze the user's face, fingerprints, gestures, and/or other biometric personal data tracked by the camera 224. The camera 224 can operate to perform an optical character recognition of data including text and/or an image. The data can include one or more of the following: a typewritten text, a printed text, an image, etc.

Removable communication device 102 can include a I/O interface unit 226. The I/O interface unit 226 can include a display controller and one or more input controllers for other input or control devices. The one or more input controllers receive/send electrical signals from/to other input or control devices. In some examples, the one or more input controllers can be coupled to any of the following: a keyboard, infrared port, USB port, and/or a mouse.

Removable communication device 102 can include one or more light indicator(s) configured to show a light indication in response to various stimuli or user actions. For example, a light indicator can be used to show that removable communication device 102 has successfully connected to a receiving device, a power source, to indicate that it is charging, and/or for other reasons. In some examples, the light indicator can emit a different colored light to indicate different functions that are performed. In some examples the light indicator can flash to signify various processes.

Removable communication device 102 can include a global positioning system (GPS) unit configured to track geographical location. Removable communication device 102 can present geographical location via one or more of displaying it on the user interface 218 and/or presenting it audibly, including by a voice assistant in some examples, via a speaker and/or headphones coupled with removable communication device 102. The information gathered via the GPS unit can be applied for spatial and positional awareness tracking and for monitoring the position of a user. The GPS unit enables the use of mapping applications.

In some examples, removable communication device 102 can include wireless communication interface(s) and/or radio(s). The wireless communication interface(s) and/or radio(s) can be useful when the user uses the removable communication device 102 to make a physical and/or electrical connection to the receiving device, and the user desires to continue to control the receiving device even after the physical and/or electrical connection is lost. In some examples, removable communication device 102 can use the wireless communication interface(s) and/or radio(s) to connect to one or more external electronic device(s) that may not be configured to make a physical and/or electrical connection to the removable communication device. Example external electronic devices that may not be configured to make a physical and/or electrical connection to removable communication device 102 can include a smartphone, a tablet, and/or a computer, etc. Example wireless communication interface(s) and/or radio(s) can include short-wavelength ultra-high frequency (UHF) radio waves in the ISM band from 2.4000 to 2.485 GHz (BLUETOOTH®) and/or WIFI.

FIG. 3 is a schematic view of an example removable communication device 102 communicatively coupling to a receiving device 304 via a physical and/or electrical connection, in accordance with examples of the disclosure. In some examples, removable communication device 102 can communicatively couple to the receiving device 304 via a magnetic connection. The example receiving device in FIG. 3 is depicted as headphones; the receiving device can be any other device configured to make a physical and/or electrical connection to removable communication device 302.

In at least one example, the receiving device 304 can include one or more over-the-ear headphones and the removable communication device 102 can be configured to make a physical connection to the receiving device 304 so that the touchscreen 122 of the removable communication device 102 is configured to face inward, as in toward the ear of the user, and the cover 120 is configured to face outward, away from the ear of the user. In some examples, the receiving device 304 can include one or more over-the-ear headphones and the removable communication device 102 can be configured to make a physical connection to the receiving device 304 so that the touchscreen 122 of the removable communication device 102 is configured to face outward, as in away from the ear of the user, and the cover 120 can be configured to face inward, toward the ear of the user.

In some examples, the housing 118 of removable communication device 102 is in the form of a teardrop and includes a notch. The tear drop form including the notch can enable removable communication device 102 to physically connect to a protrusion of a receiving device 304. For example, FIG. 3 depicts the housing of removable communication device 102 configured to cause a pressure fit 306 arrangement between removable communication device 102 and the receiving device 304. The arrangement of the pressure fit 306 enables removable communication device 102 to make a physical and/or electrical connection to the receiving device 304.

After removable communication device 102 is communicatively coupled to the receiving device 304 via a physical and/or electrical connection, removable communication device 102 can provide an indication that it has successfully been communicatively coupled to the receiving device 304. For example, the indication can be a pop up on the user interface 218, a sound, a vibration, and/or a light indication. In some examples, the user can confirm that removable communication device 102 and the receiving device 304 have been communicatively coupled via physical and/or electrical connection by selecting an option on the user interface 218. In some examples, the connection is automatic, and the user does not have to confirm that removable communication device 102 and the receiving device 304 have been communicatively coupled.

After removable communication device 102 has been communicatively coupled to the receiving device 304 via a physical and/or electrical connection, removable communication device 102 can present the customized user interface 218 specific to the receiving device 304. For example, in FIG. 3, the receiving device 304 is headphones and the user interface 218 of removable communication device 102 can display applications and/or functions related to the receiving device 304. For examples, applications and/or functions relating to the receiving device 304 can include playing music, downloading music, displaying multiple playlists, and/or changing the volume settings, etc.

After removable communication device 102 has been communicatively coupled to the receiving device 304 via a physical and/or electrical connection, removable communication device 102 can control the receiving device 304 and improves the efficient and effective use of the receiving device 304. For example, removable communication device 102 can control the volume via the user interface 218, the mechanical button(s) 308, and/or via voice commands.

After removable communication device 102 has been communicatively coupled to the receiving device 304 via a physical and/or electrical connection, removable communication device can share and/or exchange data with the receiving device 304. For example, removable communication device 102 can share photos, audio, video, internet capability, and/or other types of data that the receiving device is configured to share and/or receive.

In one example, removable communication device 102 has a bidirectional power bus that comprises a connection between the battery system and the power transfer connectors of removable communication device 102. The bidirectional power bus is configured to enable the power transfer connectors to provide power to the receiving device 304 that is physically and/or electrically connected to removable communication device 102. The bidirectional power bus enables removable communication device 102 to receive power from the receiving device 304.

In one example, removable communication device 102 contains a power management module configured to control the amount of power transferred between removable communication device 102 and the receiving device 304. For example, the power management module can be enabled to transfer enough power between removable communication device 102 with a drained battery system and the receiving device 304 in order to use removable communication device 102, and in some instances not enough power to be enough to charge the removable communication device 102. In some examples, the power management module enables the amount of power transferred to be enough to charge a receiving device's battery for future independent use of that receiving device. In some examples, removable communication device 102 can use the power management module to transfer enough power to the receiving device 304 keep the receiving device 304 from losing all battery power, and in some instances not enough power to charge the battery of the receiving device 304.

Removable communication device 102 can display information related to the power management module on the user interface. For example, the user interface displays the availability of other receiving device(s) from which power can be accessed, the current power status of removable communication device 102, the current power status of the receiving device 304 while the receiving device 304 is communicatively coupled to removable communication device 102, and/or to enable the user to specify power transfer preferences.

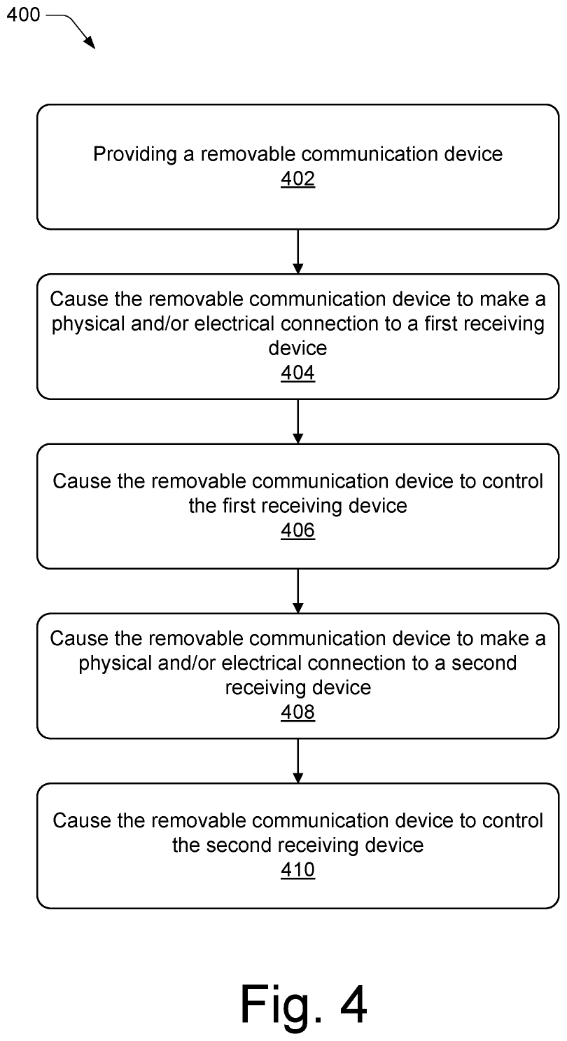

FIG. 4 is a flow diagram illustrating a method 400 of connecting a removable communication device to receiving devices, according to one example of the present disclosure.

As illustrated, the method 400 of connecting the removable communication device to one or more receiving device(s) includes the steps of: providing a removable communication device 402, causing 404 the removable communication device to make a physical and/or electrical connection to a first receiving device; causing 406 the removable communication device to control the first receiving device; causing 408 the removable communication device to make a physical and/or electrical connection to a second receiving device; and causing 410 the removable communication device to control the second receiving device.

In some examples, the first receiving device is a device that contains a display or user interface. For example, the first receiving device can be a television, a smartphone, a tablet, a computer, etc. In some examples, the first receiving device does not contain a display or user interface, such as a speaker, a thermostat, headphones, or a vehicle. In some examples, the first receiving device can be any device configured to make an electrical and/or physical connection to the removable communication device.

In some examples, the second receiving device is of a different type than the first receiving device. For example, the first receiving device can include the function of playing music, such as a speaker, while the second receiving device can include the function of controlling the temperature in the user's environment, such as a thermostat.

In some examples, the removable communication device continues to be communicatively coupled to the first receiving device via a wireless network even after a physical and/or electrical connection is lost. This enables the removable communication device to be communicatively coupled to multiple receiving devices in an environment.

In some examples, the removable communication device is communicatively coupled to the first receiving device via a Bluetooth connection while being physically and/or electrically connected to the second receiving device. In some examples, the removable communication device can be configured to operate and/or control both the first receiving device and the second receiving device independently.

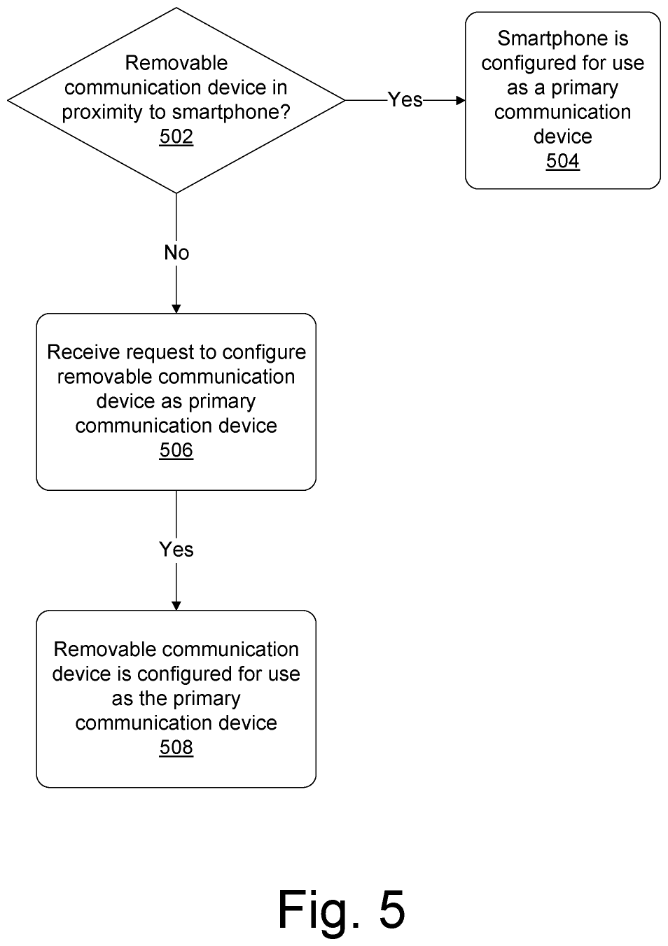

FIG. 5 is a flow diagram of an example process 500 for determining whether the removable communication device is operable as a primary communication device, in accordance with examples of the disclosure.

The example processes 500 may start with determining that a removable communication device is in proximity to a smartphone 502. If yes, the smartphone can be configured for use as the user's primary communication device 504. A primary communication device is a communication device that is in proximity to the user and that is the focus of the user's attention, engagement, or focus. A secondary communication device is any other communication device that is in proximity to the user and has the user's attention, engagement, and/or focus.

As shown in FIG. 5, if the removable communication device detects a smartphone in proximity to the removable communication device, the smartphone is configured for use as the primary communication device 504.

In some examples, if the removable communication device does not detect a smart phone in proximity, or no longer detects the smartphone in proximity to the removable communication device, the removable communication device can be configured to receive a request to configure the removable communication device to function as the primary communication device 506. The request, in some examples, can be a pop up on the user interface of the removable communication device. Following a response to the request, the removable communication device can be configured for use as the primary communication device 508.

In some examples, the removable communication device no longer detects the smartphone because the battery of the smartphone has been depleted, or because the user has moved too far away from the smartphone, and/or because the smartphone is no longer connected to a mobile network.

In some examples, the user customizes the notification settings in the removable communication device to provide a warning or indication that the smartphone is no longer in proximity to the removable communication device. The warning or indication can be associated with a pop up on the user interface of the removable communication device, a sound, and/or a light indicator on the removable communication device.

In some examples, the removable communication device is configured to automatically function as the primary communication device, without input from the user, when it no longer detects the smartphone in proximity In some examples, the removable communication device can no longer detect the smartphone in proximity because the smartphone battery has been depleted, or the smartphone is malfunctioning, and/or the smartphone is no longer connected to the mobile network.

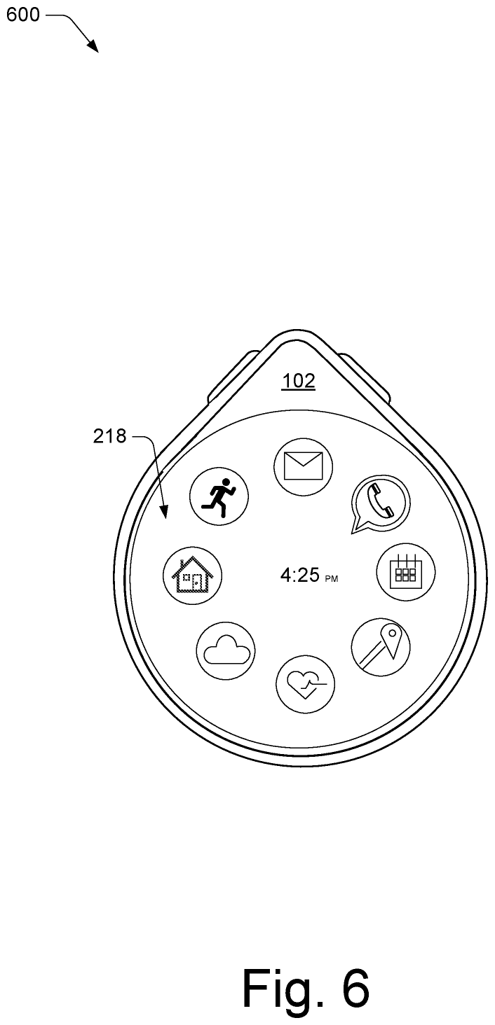

FIG. 6 is a schematic diagram of an example user interface 218. Removable communication device 102 is configured to display a user interface 218 that provides an easy-to-use interface between a user of the removable communication device 102 and the operating system or application. The user interface 218 can display and/or represent one or more element(s), programs, files, icons, applications, graphical images including menus, buttons, scroll bars, etc. These elements or graphical images can be arranged in a predefined layout or can be created dynamically to serve the specific actions taken by the user. The user can select and/or activate various graphical images to initiate tasks and/or functions associated with the various graphical images. In some examples the user interface 218 includes elements and/or graphical images that are non-interactive.

In some examples, the elements or graphical images are associated with one or more control options that can be selected by the user. The control options can include one or more control buttons for implementing various tasks. For example, the control option can include music listening control buttons such as play, pause, seek, and/or menu.

In some examples, the user interface 218 can display icons, one or more application(s), and/or the current time. One or more functions of the user interface 218 can be adjusted and/or varies from one application to the next and/or within a respective application. In some examples, the user interface 218 can be customized based at least in part on the receiving device or the type of receiving device removable communication device 102 is communicatively coupled to. For example, if removable communication device 102 is communicatively coupled to headphones 108, the user interface 218 of removable communication device 102 can be customized to display one or more elements and/or graphical images that are relevant to the use and control of the headphones 108. For example, the user interface 218 can display one or more of the current track the user is listening to, volume level, a play list, play, pause, fast forward, rewind/repeat, next track, previous track, etc. controls, elements and/or graphical images that are relevant to noise-cancelling features of the headphones 108 and/or other functions related to the ambient sound of the environment of the headphones 108.

Although examples have been described in language specific to structural features and/or methodological acts, it is to be understood that the disclosure is not necessarily limited to the specific features or acts described. Rather, the specific features and acts are described as illustrative forms of implementing the examples. In various examples, any of the structural features and/or methodological acts described herein can be rearranged, modified, or omitted entirely.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

I/We claim:

1. A method comprising:
providing a removable communication device;
configuring the removable communication device to cause the removable communication device to make a physical and/or electrical connection to a first receiving device, wherein the first receiving device is of a first type and is configured to receive the removable communication device;
configuring the removable communication device to cause the removable communication device to control the first receiving device while the removable communication device remains in communication with the first receiving device; and
configuring the removable communication device to cause the removable communication device to make another physical and/or electrical connection to a second receiving device, wherein the second receiving device is of a second type different than the first type and is configured to receive the removable communication device.

2. A method as claim 1 recites, further comprising:
determining that the removable communication device is in proximity to a smartphone, wherein the smartphone is configured for use as a primary communication device;
determining that the removable communication device is no longer in proximity to the smartphone;
receiving a request to configure the removable communication device to function as the primary communication device; and
configuring, in response to the request, the removable communication device to function as the primary communication device.

3. A method as claim 1 recites, wherein the removable communication device is configured to share battery power with the first receiving device while the removable communication device is in physical and/or electrical communication with the receiving first device.

4. A method as claim 1 recites, wherein the removable communication device is configured to share data with the first receiving device while the removable communication device is in communication with the first receiving device.

5. A method as claim 1 recites, further comprising:
causing a touchscreen associated with the removable communication device to present a customized user interface specific to the first receiving device or the second receiving device.

6. A removable communication device comprising:
a touchscreen;
a housing;
one or more processors; and
one or more computer-readable media having thereon processor-executable instructions, which upon execution, configure the one or more processors to perform operations comprising:
configuring the removable communication device to cause the removable communication device to make a physical and/or electrical connection to a first receiving device, wherein the first receiving device is of a first type and is configured to receive the removable communication device;
configuring the removable communication device to cause the removable communication device to control the first receiving device while the removable communication device remains in communication with the first receiving device; and
configuring the removable communication device to cause the removable communication device to make another physical and/or electrical connection to a second receiving device, wherein the second receiving device is of a second type different than the first type and is configured to receive the removable communication device.

7. A removable communication device as claim 6 recites, further comprising:
a battery system;
a memory unit;
a microphone;
a camera; and/or
a radio configured to connect to at least one of a CDMA or a GSM network antenna.

8. A removable communication device as claim 6 recites, wherein the housing is formed from at least one of plastic, metal, and/or ceramic.

9. A removable communication device as claim 6 recites, wherein the removable communication device is between at least about 50 millimeters and at most about 100 millimeters in diameter.

10. A removable communication device as claim 6 recites, wherein the housing includes at least one protrusion and/or an indentation configured to receive a cover having a pressure fit arrangement on a side opposite the touchscreen.

11. A removable communication device as claim 6 recites, wherein the removable communication device is configured to operate as a smartphone.

12. A removable communication device as claim 6 recites, further comprising a voice command module configured to transform a voice communication received from a microphone located on the removable communication device and convert the voice communication into an electrical signal.

13. A removable communication device as claim 6 recites, further comprising a user interface customization module configured to cause the touchscreen to present a customized user interface specific to the first receiving device, the customized user interface configured to display at least one feature specific to controlling the first receiving device.

14. A removable communication device as claim 6 recites, wherein the physical and/or electrical connection to the first receiving device enables power to be shared between the removable communication device and the first receiving device.

15. A system comprising:
a first receiving device; and
a removable communication device including:
one or more processors;
one or more computer-readable media having thereon processor-executable instructions, which upon execution, configure the one or more processors to perform operations comprising:
configuring the removable communication device to cause the removable communication device to make a physical and/or electrical connection to the first receiving device, wherein the first receiving device is of a first type and is configured to receive the removable communication device;
configuring the removable communication device to cause the removable communication device to control the first receiving device while the removable communication device remains in communication with the first receiving device; and
configuring the removable communication device to cause the removable communication device to make another physical and/or electrical connection to a second receiving device, wherein the second receiving device is of a second type different than the first type and is configured to receive the removable communication device.

16. A system as claim 15 recites, wherein a user interface associated with the removable communication device is configured to control the first receiving device or the second receiving device differently according to a type of the first receiving device or the second receiving device.

17. A system as claim 15 recites, wherein the physical and/or electrical connection to the first receiving device enables the removable communication device to control the first receiving device via a voice command.

18. A system as claim 15 recites, the operations further comprising:
configuring the first receiving device to respond to a voice communication received from a microphone located on the removable communication device.

19. A system as claim 15 recites, wherein the removable communication device is configured to share battery power with the first receiving device while the removable communication device is in physical and/or electrical connection to the first receiving device.

20. A system as claim 15 recites, wherein the physical and/or electrical connection to the first receiving device enables the removable communication device to control the first receiving device via a touchscreen on the removable communication device.
